(19) United States
(12) Patent Application Publication
(10) Pub. No.: US 2026/0122502 A1
(43) Pub. Date: Apr. 30, 2026

(54) EDGE-BASED SECURITY SERVICE FOR ROAMING USER DEVICES IN COMMUNICATION NETWORKS

(71) Applicant: T-MOBILE INNOVATIONS LLC, Overland Park, KS (US)

(72) Inventor: Anis Adil Anis, Bay Point, CA (US)

(21) Appl. No.: 18/925,926

(22) Filed: Oct. 24, 2024

(51) Int. Cl. H04W 12/37; H04W 8/02

(52) U.S. Cl. CPC H04W 12/37; H04W 8/02

(57) ABSTRACT

Various embodiments include a system that comprises a network controller and a user plane in a home communication network. The network controller receives a session request from a visited communication network for a roaming user device that is roaming on the visited communication network. The session request indicates an edge security platform of the home communication network. The network controller selects the user plane with a communication link to the edge security platform. The network controller directs the user plane to support a session for the roaming user device. The network controller transfers a response to the visited communication network to begin the session. The user plane exchanges user data with the visited communication network. The visited communication network exchanges the user data with the roaming user device. The user plane exchanges the user data with the edge security platform.

The edge security platform enforces security policies on the session.

### TECHNICAL FIELD

Various embodiments of the present technology relate to roaming, and more specifically, to enabling edge-based security services for roaming user devices.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Edge based security services provide security controls at a point of access instead of routing traffic to a data center where security policies are enforced. Points of access may include a user device, an Internet-of-Things (IoT) device, an access network, an edge computing location, and the like. Secure Access Service Edge (SASE) is a type of edge-based security service. SASE ensures real-time, context aware policy enforcement to secure user and device traffic. SASE comprises a flexible zero trust architecture that enforces security policies on data sessions between user devices and enterprise networks and/or the public internet. SASE encompasses a range of security solutions, including Zero Trust Network Access (ZTNA), Secure Web Gateways (SWG), Cloud Access Security Brokers (CASB), Firewall as a Service (FWaaS), and the like. This integrated approach allows SASE to provide secure and optimized connectivity to cloud services, applications, and resources from any location or device.

Wireless communication networks provide service to user devices in geographic regions referred to as service areas. The service areas of different wireless communication networks often overlap, however this is not always the case. When a wireless user device leaves the service area of its network (referred to as the home network) and enters the service area of another network (referred to as the visited network), the user device may roam on the visited network to maintain wireless connectivity. When roaming, the visited network routes signaling and data received from the user device back to the user device's home network. The home network routes the signaling and data to the intended endpoints. Unfortunately, in some cases, wireless communication networks may not effectively or efficiently enable edge-based security services like SASE for roaming user devices.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for roaming.

Some embodiments comprise a method. The method comprises receiving, by a network controller in a home communication network from a visited communication network, a session request for a roaming user device that is roaming on the visited communication network. The session request at least indicates an edge security platform of the home communication network. The method further comprises selecting, by the network controller, a user plane in the home communication network with a communication link to the edge security platform. The method further comprises directing, by the network controller, the user plane to support a session for the roaming user device with the visited communication network. The method further comprises transferring, by the network controller, a response to the visited communication network to begin the session. The method further comprises exchanging, by the user plane, user data for the session with the visited communication network. The visited communication network exchanges the user data for the session with the roaming user device. The method further comprises exchanging, by the user plane, the user data for the session with the edge security platform. The edge security platform enforces security policies on the session.

Some embodiments comprise a system. The system comprises a network controller and a user plane in a home communication network. The network controller receives a session request from a visited communication network for a roaming user device that is roaming on the visited communication network. The session request at least indicates an edge security platform of the home communication network. The network controller selects a user plane in the home communication network with a communication link to the edge security platform. The network controller directs the user plane to support a session for the roaming user device with the visited communication network. The network controller transfers a response to the visited communication network to begin the session. The user plane exchanges user data for the session with the visited communication network. The visited communication network exchanges the user data for the session with the roaming user device. The user plane exchanges the user data for the session with the edge security platform. The edge security platform enforces security policies on the session.

Some embodiments comprise one or more non-transitory computer readable storage media having program instructions stored thereon. When executed by a computing system, the program instructions direct the computing system to perform operations. The operations comprise receiving, in a home communication network, a session request from a visited communication network for a roaming user device that is roaming on the visited communication network. The session request at least indicates an edge security platform of the home communication network. The operations further comprise selecting a user plane with a communication link to the edge security platform. The operations further comprise directing the user plane to support a session for the roaming user device with the visited communication network. The operations further comprise transferring a response to the visited communication network to begin the session. The user plane exchanges user data for the session with the visited communication network and exchanges the user data for the session with the edge security platform. The visited communication network exchanges the user data for the session with the roaming user device. The edge security platform enforces security policies on the session.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example communication network to enable edge-based security service for roaming user devices.

FIG. 2 illustrates an example operation of the communication network to enable edge-based security service for roaming user devices.

FIG. 3 illustrates another example operation of the communication network to enable edge-based security service for roaming user devices.

FIG. 4 illustrates an example Fifth Generation (5G) communication network to enable edge-based security service for roaming user devices.

FIG. 5 further illustrates the 5G communication network to enable edge-based security service for roaming user devices.

FIG. 6 illustrates an example 5G User Equipment (UE) in the 5G communication network.

FIG. 7 illustrates an example non-Third Generation Partnership Project (3GPP) UE in the 5G communication network.

FIG. 8 illustrates an example 5G Radio Access Network (RAN) in the 5G communication network.

FIG. 9 illustrates an example non-3GPP Access Network (AN) in the 5G communication network.

FIG. 10 illustrates example network functions in the 5G communication network.

FIG. 11 illustrates an example 5G data center and Secure Access Service Edge (SASE) in the 5G communication network.

FIG. 12 further illustrates the 5G data center in the 5G communication network.

FIG. 13 illustrates an example operation of the 5G communication network to enable edge-based security service for roaming user devices.

FIG. 14 illustrates an example Long Term Evolution (LTE) communication network to enable edge-based security service for roaming user devices.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

Some conventional wireless communication networks enable edge-based security services for select user devices. Edge based security services provide security controls at a point of access (e.g., user device, access network, edge computing location, etc.) instead of routing traffic to a data center where security policies are enforced. An exemplary edge-based security service is Secure Access Service Edge (SASE) which provides secure and optimized connectivity to cloud services, applications, and resources from any location or device. When a user device attaches to the network, the network accesses a subscriber profile for the user device to determine authorized services for the device. When the device requests and is authorized for edge-based security service, the network routes traffic for the device to an edge-based security platform like SASE. However, conventional networks with edge-based security capability do not effectively interface with neighbor networks to provide edge-based security service over the neighbor networks. This inhibits roaming user devices that subscribe for edge-based security service from receiving their subscribed services which negatively impacts the user experience.

To overcome the above-described problems, various embodiments of the present technology relate to enabling edge-based security service for roaming user devices. In some examples, a wireless communication network comprises a user plane with dedicated connectivity to an edge-based security platform. A network controller in the wireless communication network processes service requests for roaming user devices received from neighbor communication networks. When the service requests include an Identifier (ID) for the user plane with dedicated connectivity to the edge-based security platform, the network controller directs the neighbor network to route traffic for the roaming user device to the user plane with dedicated connectivity to the edge-based security platform. The ID may comprise a Data Network Name (DNN), Access Point Name (APN), and the like. By routing traffic for roaming user devices to this user plane, the communication network enables edge-based security service for the roaming devices thereby improving the overall user experience. Now referring to the Figures.

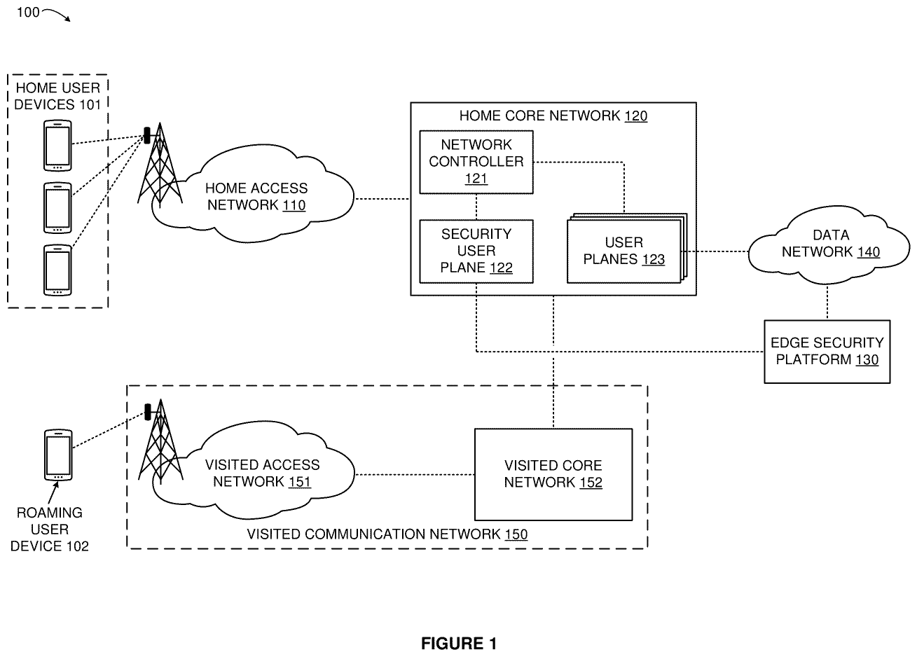

FIG. 1 illustrates home communication network 100 and visited communication network 150 to provide edge-based security service to roaming user devices. Home communication network 100 provides services like media-streaming, internet-access, voice/video calling, text messaging, machine communications, or some other wireless communications product. Home communication network 100 comprises home user device 101, roaming user device 102, home access network 110, home core network 120, edge security platform 130, and data network 140. Home core network 120 comprises network controller 121, security user plane 122, and user planes 123. Visited communication network 150 comprises visited access network 151 and visited core network 152. In other examples, home communication network 100 and visited communication network 150 may comprise additional or different elements than those illustrated in FIG. 1.

Various examples of network operation and configuration are described herein. In some examples, home core network 120 serves home user devices 101 over home access network 110. Network controller 121 authenticates and authorizes home user devices 101 for service on home communication network 100. Home user devices 101 exchange user data with security user plane 122 and/or user planes 123 over home access network 110. Security user plane 122 is communicatively linked with edge security platform 130 and exchanges the user data with edge security platform 130. Edge security platform 130 enforces security policies on the data sessions before delivering the data to data network 140. User planes 123 are not communicatively linked with edge security platform 130 and exchange the user data with data network 140. Network controller 121 controls the use of security user plane 122 by home user devices 101. For example, network controller 121 may block unauthorized ones of home user devices 101 from using security user plane 122 and may allow authorized ones of home user device 101 to use security user plane 122.

Roaming user device 102 is outside of the wireless service area of home communication network 100. For example, roaming user device 102 may not be located in the geographic region served by home access network 110. In response, roaming user device 102 elects to roam on visited communication network 150. Roaming user device 102 transfers a session request to visited core network 152 over visited access network 151. The session request indicates (i.e., requests service on) security user plane 122. For example, the session request may include an ID like DNN or APN associated with security user plane 122. Visited core network 152 detects that roaming user device 102 is roaming on visited communication network 150 and in response, routes the session request to network controller 121 in home core network 120. Network controller 121 selects security user plane 122 based on the indication in the session request. For example, network controller 121 may authorize roaming user device 102 for service a security user plane. In response, network controller 121 may select from a pool of user planes 122 and 123, security user plane 122 based on the authorization. Network controller 121 directs security user plane 122 to serve roaming user device 102 and transfers a session request response to visited communication network 150 to begin the session. Security user plane 122 exchanges user data with roaming user device over visited communication network 150. Security user plane 122 exchanges the user data with edge security platform 130. Edge security platform 130 enforces security policies on the session and exchanges the user data with data network 140.

Advantageously, home communication network 100 effectively enables edge security services for roaming user devices. Moreover, home communication network 100 efficiently includes a user plane with dedicated connectivity to an edge security platform.

Home user devices 101 and roaming user device 102 may comprise phones, computers, vehicles, drones, robots, sensors, or other types of data appliance with wireless and/or wireline communication circuitry. Home user devices 101, roaming user device 102, home access network 110, and visited access network 151 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WIFI), Low-Power Wide Area Network (LP-WAN), Bluetooth, and/or some other type of wireless or wireline networking protocol. The wireless technologies may use electromagnetic frequencies in the low-band, mid-band, high-band, or some other portion of the electromagnetic spectrum. The wired connections may comprise metallic links, glass fibers, and/or some other type of wired interface.

Although home access network 110 and visited access network 151 are illustrated as comprising towers, access networks 110 and 151 may comprise other types of mounting structures (e.g., buildings), or no mounting structures at all. Access networks 110 and 151 comprise Sixth Generation (6G) Radio Access Networks (RANs), Fifth Generation (5G) RANs, LTE RANs, gNodeBs, eNodeBs, NB-IoT access nodes, trusted non-Third Generation Partnership Project (3GPP) access nodes, untrusted non-3GPP access nodes, LP-WAN base stations, wireless relays, WIFI hotspots, Bluetooth access nodes, and/or another wireless or wireline network transceiver. While illustrated as comprising terrestrial systems, access networks 110 and 151 may comprise non-terrestrial (e.g., satellite based) access networks. Home access network 110 exchanges network signaling and user data with network controller 121 and user planes 122 and 123 that are clustered together into home core network 120. Visted access network 151 exchanges network signaling and user data with network controller(s) and user plane(s) clustered together into visited core network 152. Home access network 110 is connected to home core network 120 over backhaul data links and visited access network 151 is connected to visited core network 152 over backhaul data links. Access networks 110 and 151 and core networks 120 and 152 may communicate via edge networks like internet backbone providers, edge computing systems, or another type of edge system to provide the backhaul data links between access networks 110 and 151 and core networks 120 and 152.

Access networks 110 and 151 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core networks 120 and 152. Access networks 110 and 151 may comprise Baseband Units (BBUs). The BBUs handle lower and higher network layers like RRC, PDCP, RLC, MAC, and PHY. The BBUs are coupled to network entities in core networks 120 and 152.

Home core network 120 and visited core network 152 are representative of computing systems that provide wireless data services to home user devices 101 and roaming user device 102 over home access network 110 and visited access network 151. The computing systems may comprise Network Function Virtualization Infrastructure (NFVI) systems, data centers, server farms, cloud computing networks, hybrid cloud networks, and the like. Core networks 120 and 152 may comprise a 3GPP core network architecture like Sixth Generation Core (6GC), Fifth Generation Core (5GC), Evolved Packet Core (EPC), and/or another type of 3GPP core network architecture. Home access network 110, visited access network 151, home core network 120, visited core network 152, edge security platform 130, and data network 140 communicate over various links that use metallic links, glass fibers, radio channels, or some other communication media. The links use 6GC, 5GC, EPC, IEEE 802.3 (Ethernet), Time Division Multiplex (TDM), Data Over Cable System Interface Specification (DOCSIS), Internet Protocol (IP), General Packet Radio Service Transfer Protocol (GTP), 6GR, 5GNR, LTE, WIFI, virtual switching, inter-processor communication, bus interfaces, and/or some other data communication protocols.

The computing systems of home core network 120 store and execute the network functions/entities to form network controller 121, security user plane 122, and user planes 123.

Network controller 121 may comprise control plane network functions/entities like Access and Mobility Management Function (AMF), Session Management Function (SMF), Unified Data Management (UDM), Policy Control Function (PCF), Authentication, Authorization, and Accounting (AAA), Security Edge Protection Proxy (SEPP), Non-3GPP Interworking Function (N3IWF), Mobility Management Entity (MME), Home Subscriber Server (HSS), Policy Charging and Rules Function (PCRF), and the like. User planes 122 and 123 comprise network functions/entities like User Plane Function (UPF), Serving Gateway (S-GW), Packet Gateway (P-GW), and the like. The computing systems of visited core network 152 may store and execute network functions/entities similarly to home core network 120.

Edge security platform 130 comprises a cloud-based computing system that applies security policies on sessions between security user plane 122 and data network 140. Edge security platform 130 may comprise a Secure Access Service Edge (SASE). Exemplary security policies include content filtering, security features, malware scanning, Domain Name System (DNS) filtering, firewalls, intrusion detection and prevention, and the like. In other examples, edge security platform 130 may provide another type of edge-based service (e.g., content distribution, media broadcasting, voice/video conferencing, etc.). Data network 140 comprises Application Server (ASs) that host the client-side portion of user applications (e.g., media streaming applications, voice/video conferencing applications, etc.) for home user devices 101 and roaming user device 102. Data network 140 may be representative of a public data network (e.g., the Internet) or a private data network (e.g., an enterprise network).

User devices 101 and 102 and access networks 110 and 151 comprise antennas, amplifiers, filters, modulation, analog/digital interfaces, microprocessors, software, memories, transceivers, bus circuitry, and the like. User devices 101 and 102, access networks 110 and 151, core networks 120 and 152, edge security platform 130, and data network 140 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of home communication network 100 and visited communication network 150 as described herein.

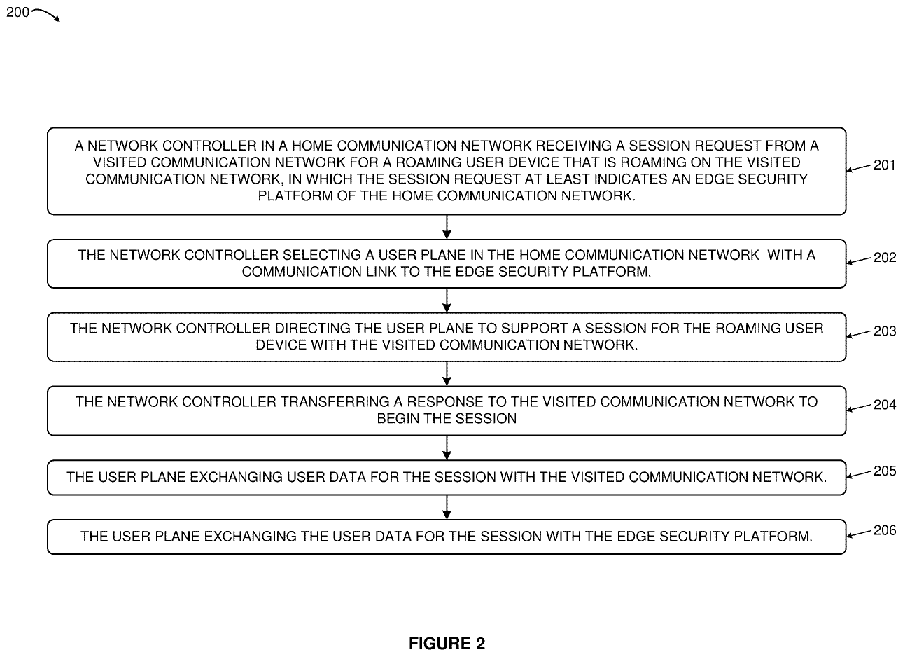

FIG. 2 illustrates process 200. Process 200 comprises an exemplary operation of home communication network 100 to provide edge-based security service to roaming user devices. The operation may vary in other examples. The operations of process 200 comprise a network controller in a home communication network receiving a session request from a visited communication network for a roaming user device that is roaming on the visited communication network, in which the session request at least indicates an edge security platform of the home communication network (step 201). The operations further comprise the network controller selecting a user plane in the home communication network with a communication link to the edge security platform (step 202). The operations further comprise the network controller directing the user plane to support a session for the roaming user device with the visited communication network (step 203). The operations further comprise the network controller transferring a response to the visited communication network to begin the session (step 204). The operations further comprise the user plane exchanging user data for the session with the visited communication network (step 205). The visited communication network exchanges the user data with the roaming user device. The operations further comprise the user plane exchanging the user data for the session with the edge security platform (step 206). The edge security platform enforces security policies on the session.

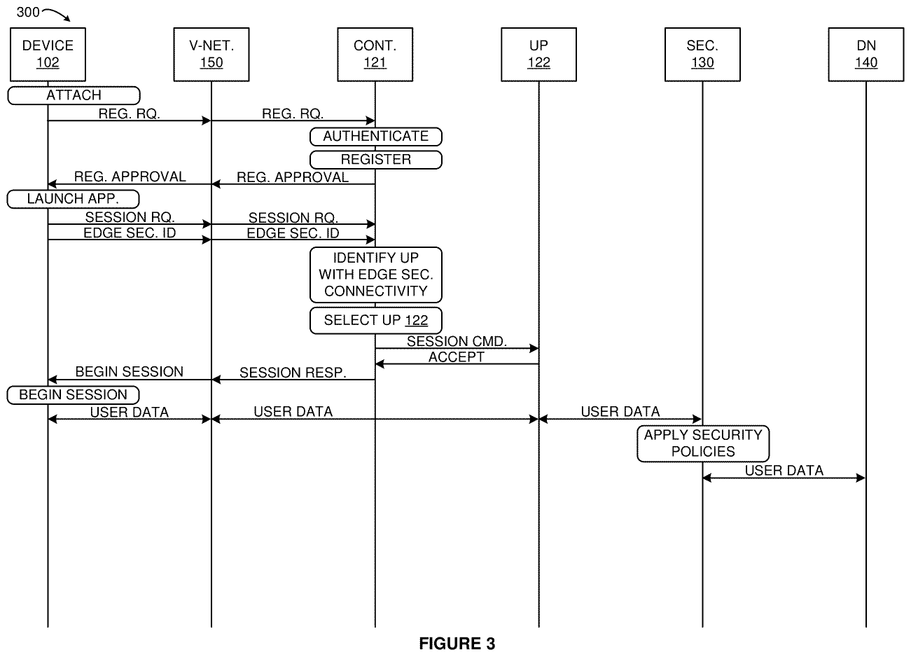

FIG. 3 illustrates process 300. Process 300 comprises an exemplary operation of home communication network 100 to provide edge-based security service to roaming user devices. Process 300 comprises an example of process 200 illustrated in FIG. 2, however process 200 may differ. The operation of process 300 may vary in other examples. In some examples, roaming user device 102 attaches to visited access network 151 in visited communication network (V-NET) 150. Roaming user device 102 and visited access network 151 implement a Random Access Channel (RACH) process to establish a radio link for roaming user device 102. Roaming user device 102 transfers a Non-Access Stratum (NAS) registration request to visited core network 152 over visited access network 151. The registration request includes information like a registration type, subscriber ID, Tracking Area ID (TAI), Network Slice Selection Assistance Information (NSSAI) requests, User Equipment (UE) capabilities, Protocol Data Unit (PDU) session requests, and the like. Exemplary subscriber IDs include Subscriber Concealed Identifier (SUCI), Subscriber Permanent Identifier (SUPI), International Mobile Subscriber Identifier (IMSI), Fifth Generation Global Unique Temporary Identifier (5G-GUTI), and the like. Visited core network 152 identifies that roaming user device 102 is roaming on visited communication network 150 from home communication network 100. For example, the registration request may include a parameter that identifies the Home Public Land Mobility Network (HPLMN) of roaming user device 102. In response, visited core network 152 routes the registration request to network controller (CONT.) 121. Network controller 121 authenticates and registers roaming user device 102 for wireless data services. Network controller 121 transfers a registration approval message to roaming user device 102 over visited communication network 150. The registration approval comprises data like IP address, network controller ID, access network ID, bit rate, session setup information, selected network slices, and the like.

Once registered, roaming user device 102 launches a user application and transfers a session request for the application to visited core network 152 over visited access network 151. The session request includes an edge security (SEC.) ID (e.g., DNN, APN, etc.) associated with security user plane (UP) 122. Visited core network 152 routes the session request to network controller 121. Network controller 121 identifies the edge security ID in the session request. Network controller 121 accesses a subscriber profile for roaming user device 102 stored by a network data system, such as a subscriber information database of the home communication network 100 to authorize the requested session. The subscriber profile comprises a set of subscriber attributes that indicate authorized service for roaming user device 102. In this example, the subscriber attributes indicate roaming user device 102 is subscribed for edge-based security service. In response, network controller 121 authorizes roaming user device 102 for service on a user plane with edge security capability.

Network controller 121 examines user planes 122 and 123 and identifies that security user plane 122 is communicatively coupled with edge security platform (SEC.) 130. For example, network controller 121 may determine that security user plane 122 serves the DNN or APN associated with edge security platform 130. Network controller 121 transfers a session command (CMD.) to security user plane 122 that directs security user plane 122 to support the session. Security user plane 122 responds to network controller 121 with an acceptance message to acknowledge the command. Network controller 121 transfers a session response (RESP.) to visited network core 152 to direct visited communication network 150 to serve roaming user device 102 and that indicates security user plane 122 as the data routing entity in home core network 120. Visited core network 152 configures visited access network 151 to serve the session. Visited core network 152 directs to roaming user device 102 to begin the session. Roaming user device 102 exchanges user data with visited core network 152 over visited access network 151. Visited core network 152 routes the user data to security user plane 122 based on the session response message. Security user plane 122 exchanges the user data with edge security platform 130. Edge security platform 130 enforces security policies on the packet flow. For example, edge security platform 130 may perform content filtering, session security, malware scanning, DNS filtering, firewalling, intrusion detection, intrusion prevention, and the like. Edge security platform 130 exchanges the user data with data network 140.

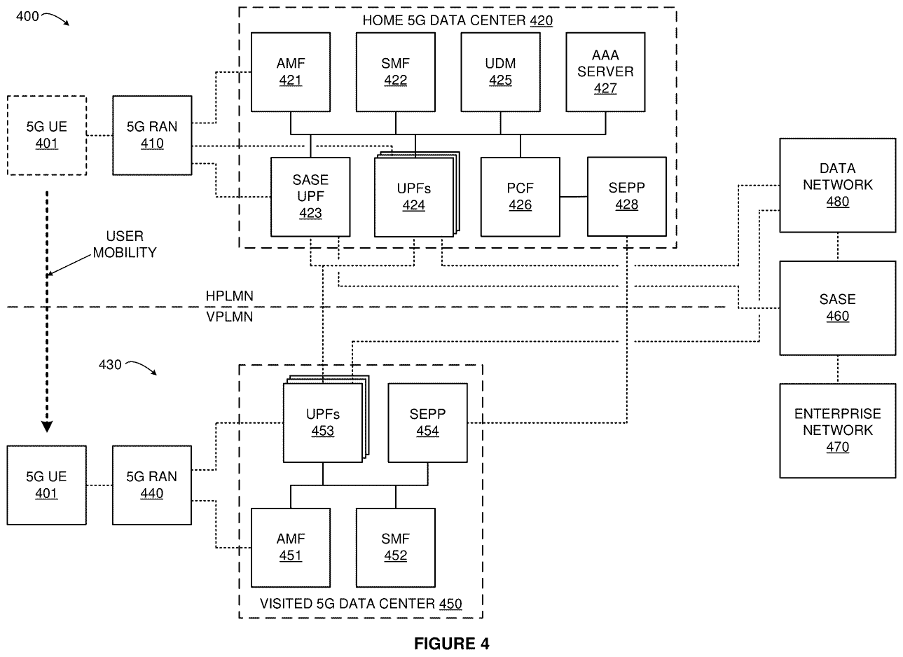

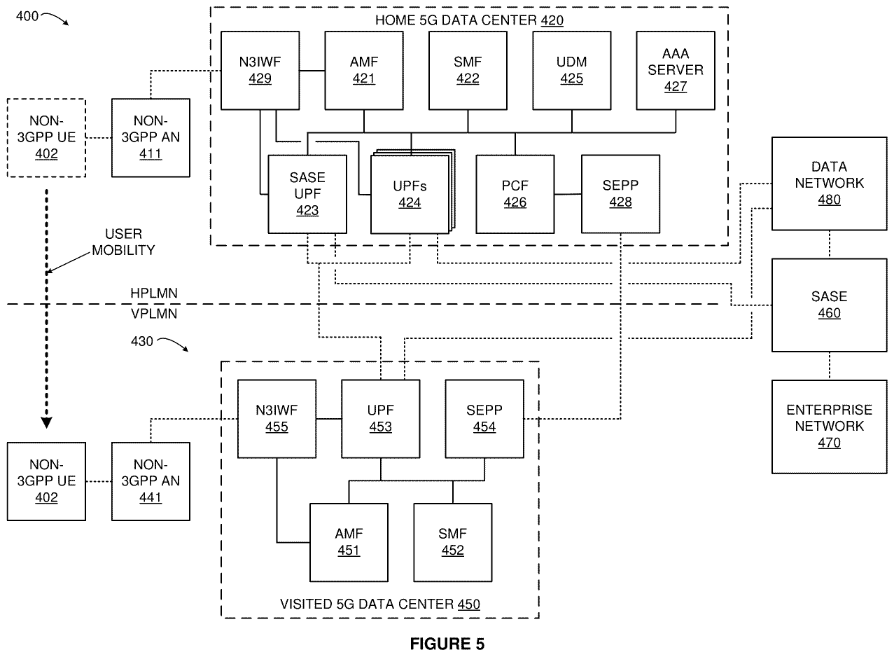

FIG. 4 illustrates home 5G communication network 400 and visited 5G communication network 430 to provide edge-based security service to roaming user devices. Home 5G communication network 400 comprises an example of home communication network 100 illustrated in FIG. 1, however network 100 may differ. Home 5G communication network 400 comprises 5G UE 401, non-3GPP UE 402, 5G RAN 410, non-3GPP Access Network (AN) 411, home 5G data center 420, SASE 460, enterprise network 470, and data network 480. Home 5G data center 420 comprises AMF 421, SMF 422, SASE UPF 423, UPFs 424, UDM 425, PCF 426, AAA server 427, SEPP 428, and N3IWF 429. Visited 5G communication network 430 comprises 5G RAN 440, non-3GPP AN 441, and visited 5G data center 450. Visited 5G data center 450 comprises AMF 451, SMF 452, UPFs 453, SEPP 454, and N3IWF 455. Non-3GPP UE 402, non-3GPP ANs 411 and 441, and N3IWFs 429 and 455 are omitted from FIG. 4 for clarity, however these components are illustrated in FIG. 5. Other network functions and network entities like Network Slice Selection Function (NSSF), Authenticating Server Function (AUSF), Unified Data Registry (UDR), HSS, Home Subscriber Register (HLR), Network Repository Function (NRF), Short Message Service Function (SMSF), Network Exposure Function (NEF), Application Function (AF), Equipment Identity Register (EIR), and Session Communication Proxy (SCP) are typically present in home 5G data center 420 but are omitted for clarity. In other examples, home 5G communication network 400 may comprise different or additional elements than those illustrated in FIG. 4.

In some examples, 5G UE 401 starts within the service area of 5G RAN 410. 5G UE 401 wirelessly attaches to 5G RAN 410 over a 5GNR link. 5G UE 401 undergoes a RACH procedure with 5G RAN 410 to establish a secure signaling channel. 5G UE 401 transfers a registration request to AMF 421 over 5G RAN 410. The registration request indicates a registration type, 5G-GUTI, TAI, NSSAI requests, UE capabilities, requests for PDU sessions with enterprise network 470, and the like. In response to the registration request, AMF 421 transfers a NAS identity request to 5G UE 401 over a NAS signaling link between 5G UE 401 and AMF 421 that traverses RAN 410. 5G UE 401 indicates its SUCI to AMF 421 over the NAS link that traverses 5G RAN 410. AMF 421 requests authentication vectors from and indicates 5G UE 401's SUCI to UDM 425 (typically via an AUSF). UDM 425 accesses the subscriber profile for 5G UE 401 and derives the SUPI for 5G UE 401 based on the SUCI. The SUPI comprises the IMSI associated with the Subscriber Identity Module (SIM) card for 5G UE 401. UDM 425 generates authentication vectors for 5G UE 401. UDM 425 returns the vectors and SUPI to AMF 421. The authentication vectors comprise a random number, expected result, key selection criteria, and the like. AMF 421 transfers an authentication challenge that comprises the random number and key selection criteria to 5G UE 401 over the NAS link that traverses RAN 410. 5G UE 401 hashes random number with its secret key to generate an authentication result and indicates the authentication result to AMF 421 over the NAS link. AMF 421 matches the expected result with the authentication result received from 5G UE 401 to authenticate 5G UE 401.

Responsive to the authentication, AMF 421 transfers a context registration request to UDM 425 that includes AMF ID, a supported feature list, a Permanent Equipment Identifier (PEI) for 5G UE 401, and the like. UDM 425 indicates successful UDM registration to AMF 421. In response, AMF 421 requests access and mobility subscription data, SMS selection subscription data, and UE context in SMF data from UDM 425. UDM 425 accesses the subscriber profile for 5G UE 401 and returns the requested data. The access and mobility subscription data comprises a supported feature list for UE 401 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of Single-NSSAIs (S-NSSAIs) and associated information. The UE context in SMF data comprises PDU session and EPC interworking information. The access and mobility subscription data, SMS selection subscription data, and/or UE context in SMF data indicates 5G UE 401 is subscribed for secondary authentication with AAA server 427 and edge-based security service over SASE 460. For example, the SUPI of UE 401 may comprise a network specific identity code associated with enterprise network 470. AMF 421 forms the UE context for 5G UE 401 using the retrieved information. The UE context defines the authorized services for 5G UE 401.

AMF 421 transfers a policy creation request to PCF 426 to create a policy association for 5G UE 401. PCF 426 responds to the request with policy association information like the SUPI, GPSI, PEI, and user location information for 5G UE 401. PCF 426 subscribes to AMF 421 for event reporting like user location updates, registration state changes, communication failure events, and the like. AMF 421 creates a PCF subscription based on the policy association information and signals PCF 426 of the successful subscription creation. AMF 421 may select one or more network slices for 5G UE 401 based on the slice selection information. Wireless network slices typically comprise collections core network and RAN resources that have capabilities to provide service types (e.g., low-latency service) to UEs. For example, AMF 421 may interface with an NSSF to select a security slice for SASE users for 5G UE 401. The selected security slice may comprise SASE UPF 423, portions of 5G RAN 410, and/or other elements in home 5G communication network 400. This SASE security slice creates a dedicated virtual network segment for security services, enabling efficient data traffic management and routing for security purposes. With the security slice, users can access their data with enhanced security, efficiency, and seamless experience.

AMF 421 selects SMF 422 to serve 5G UE 401 based on SMF selection data received from UDM 425 and the network policies received from PCF 426. AMF 421 transfers a list of requested PDU sessions (as received during the registration request), a PDU session activation command, and the SUPI (that includes UE 401's IMSI) to SMF 422. AMF 421 indicates that UE 401 is subscribed for secondary authentication and service on SASE 460. SMF 422 receives the PDU session list, session activation command, and the SUPI from AMF 421. SMF 422 selects one or more of UPFs 423 and 424 to support the PDU sessions based on the received data. UPFs 423 and 424 are associated with various DNNs. The DNNs correspond to data endpoints like SASE 460, enterprise network 470, and data network 480. SASE UPF 423 serves as a dedicated gateway for SASE 460 and is associated with SASE 460's DNN. SMF 422 allocates IP addresses to 5G UE 401 for the requested PDU sessions and allocates Tunnel End Point ID (TEID) for the session. SMF 422 transfers a session modification request that includes a session endpoint identifier, IP address, session start/stop information, and TEID to the selected one(s) of UPFs 423 and 424 to set up the default bearer for 5G UE 401.

SMF 422 notifies AMF 421 that the user plane is configured to serve 5G UE 401. In response, AMF 421 registers 5G UE 401 for service on home 5G communication network 400. AMF 421 generates a registration accept message that includes the allocated IP addresses for 5G UE 401, RAN IDs, AMBR, Globally Unique AMF ID (GUAMI), PDU session data, S-NSSAI list, security data, and the like. AMF 421 transfers the registration accept message to 5G UE 401 over the NAS link that traverses RAN 410. UE 401 receives the registration accept message and begins its PDU session on home 5G communication network 400.

Subsequently and in response to user mobility, 5G UE 401 leaves the coverage area of 5G RAN 410 and enters the coverage area of 5G RAN 440 in visited 5G communication network 430. UE 401 detaches from 5G RAN 410 and elects to roam on visited 5G communication network 430. As illustrated in FIG. 4, home 5G communication network 400 comprises the HPLMN of UE 401 while visited 5G communication network 430 comprises the Visited-PLMN (VPLMN) of UE 401. UE 401 wirelessly attaches to 5G RAN 440 and transfers a PDU session request for a session with enterprise network 470 secured by SASE 460 to AMF 451. UE 401 indicates its HPLMN ID to AMF 451. The PDU session request includes requested S-NSSAI(s), the DNN for SASE 460, PDU session IDs, request type parameters, and the like. AMF 451 identifies that 5G UE 401 is roaming on visited 5G communication network 430 from home 5G communication network 400 based on the HPLMN-ID. AMF 451 transfers a PDU session context create request and indicates the HPLMN-ID of UE 401 to SMF 452.

SMF 452 creates session context for the PDU session and transfers a PDU session context create response to acknowledge the request. SMF 452 selects one of UPFs 453 to support the PDU session and transfers a session establishment request to direct the selected one of UPFs 453 to support the PDU session. The selected one of UPFs 453 acknowledges the request by transferring a session establishment response to SMF 452. Once the UPF is selected, SMF 452 transfers a PDU create session request to SMF 422 in home 5G data center 420 over SEPP 454 and SEPP 428 based on the HPLMN-ID of UE 401. SEPPs 428 and 454 serve as border governors that block unauthorized, malicious, or otherwise unwanted signaling between 5G data centers 420 and 450. The create session request identifies the selected one of UPFs 453 and includes the information received from UE 401, including the DNN for SASE 460 and a subscriber ID for UE 401 like SUCI, SUPI, IMSI, and the like.

SMF 422 receives the PDU session request from SMF 452 in visited 5G data center 450. SMF 422 identifies that the request is for a session with enterprise network 470 and the DNN is for SASE 460. SMF 422 initiates secondary authentication with AAA server 427 to authorize the session with SASE 460 and enterprise network 470 based on the PDU session request and/or UE 401's context. AAA server 427 is representative of a network entity associated with enterprise network 470 to authenticate and authorize PDU sessions with SASE 460 and enterprise network 470. Although illustrated as being located in home 5G data center 420, in some examples AAA server 427 may instead be located in enterprise network 470. When located in enterprise network 470, SMF 422 may communicate with AAA server 427 over UPF 423 and an AAA server proxy. When located in home 5G data center 420 (as illustrated in FIG. 4), SMF 422 may communicate with AAA server 427 directly. AAA server 427 operates similarly whether located in home 5G data center 420 or enterprise network 470.

SMF 422 transfers a secondary authentication request to AAA server 427. The request indicates the IMSI of UE 401. AAA server 427 maintains a registry that associates IMSIs with device phone numbers (e.g., Mobile Station International Subscriber Directory Numbers (MSISDNs)) for devices associated with SASE 460 and/or enterprise network 470. AAA server 427 correlates the IMSI of UE 401 with one of the phone numbers to authenticate and authorize UE 401 for a PDU session with enterprise network 470. AAA server 427 transfers an authorization message for UE 401's PDU session with SASE 460 and enterprise network 470 to SMF 422. The authorization message comprises a PDU session authorization, and data like policy and charging information, a list of allowed Media Access Control (MAC) addresses, a list of allowed Virtual Local Area Network (VLAN) tags, authorized session Aggregate Maximum Bit Rate (AMBR), routing information, and the like.

SMF 422 receives the authorization message from AAA server 427. In response to the session authorization, SMF 422 creates a policy association for the PDU session with PCF 426. PCF 426 provides network policies like QoS rules, latency rules, throughput rules, and the like for the PDU session. SMF 422 allocates an IP address to UE 401 for the requested PDU session and allocates TEID for the session. SMF 422 determines the DNNs served by SASE UPF 423 and UPFs 424, matches the DNN served by SASE UPF 423 with the DNN requested by UE 401, and responsively selects UPF 423 to support the PDU session. SMF 422 transfers a session modification request that includes a session endpoint identifier, IP address, session start/stop information, and TEID to SASE UPF 423 to establish the PDU session for UE 401. Responsive to UPF selection, SMF 422 registers the PDU session with UDM 425. UDM 425 stores information like SUPI, DNN, S-NSSAI, PDU session ID, SMF ID, serving PLMN ID, and the like for the PDU session. SMF 422 transfers a PDU session create response to SMF 452 that identifies SASE UPF 423, authorizes the PDU session, and that includes service information for the session like QoS rules, latency rules, throughput rules, S-NSSAIs, and the like.

SMF 452 receives the PDU session create response and indicates the network address for SASE UPF 423 to the selected one of UPFs 453. SMF 452 notifies AMF 451 that the PDU session is ready to begin. AMF 451 configures 5G RAN 440 to serve the PDU session to UE 401. AMF 451 notifies UE 401 over 5G RAN 540 that the session is ready to begin. A user application in UE 401 generates uplink data for the PDU session and UE 401 wirelessly transfers the uplink data to the selected one of UPFs 453 over the data link that traverses 5G RAN 440. The selected one of UPFs 453 routes the uplink data to SASE UPF 423. SASE UPF 423 routes the uplink data to SASE 460. SASE 460 receives the uplink data and enforces the selected security policies on the uplink data. For example, SASE 460 may perform content filtering, session security, malware scanning, DNS filtering, firewalling, intrusion detection and prevention, and the like on the PDU session. SASE 460 forwards the uplink data after enforcement of the security policies to enterprise network 470. Enterprise network 470 generates and transfers downlink data for the PDU session to SASE 460 based on the IP address (or another identifier like MSISDN) for UE 401. SASE 460 enforces the security policies on the downlink data and forwards the secure downlink data to SASE UPF 423. SASE UPF 423 routes the downlink data to the selected one of UPFs 453. The selected one of UPFs 453 transfers the downlink data to UE 401 over the data link that traverses 5G RAN 440.

FIG. 5 further illustrates home 5G communication network 400 and visited 5G communication network 430 to provide edge-based security service to roaming user devices. Similar to UE 401, non-3GPP UE 402 attaches to non-3GPP AN 411. Non-3GPP UE 402 communicates with AMF 421 over non-3GPP AN 411 and N3IWF 429 to register for service on home 5G communication network 400. AMF 421 interfaces with the other network functions in home 5G data center 420 as described with respect to 5G UE 401 to register non-3GPP UE 402 for service. Subsequently, non-3GPP UE 402 moves out of the service area of non-3GPP AN 411 and enters the service area of non-3GPP AN 441 due to user mobility. In response, non-3GPP UE 402 decides to roam on visited 5G communication network 430. Non-3GPP UE 402 attaches to non-3GPP AN 441 and transfers a PDU session request that indicates the DNN for SASE 460 to AMF 451 over non-3GPP AN 441 and N3IWF 455. SMF 422, AAA server 427, and SMF 452 operate as described with respect to 5G UE 401 to authorize the PDU session, select SASE UPF 423 based on the DNN, and provide the PDU session with edge security from SASE 460 to non-3GPP UE 402.

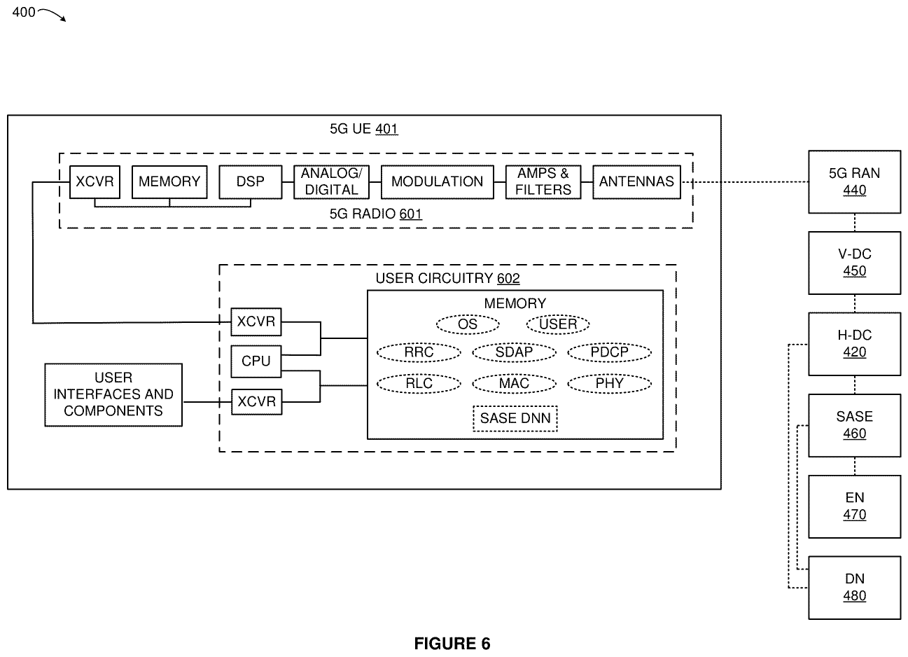

FIG. 6 illustrates 5G UE 401 in home 5G communication network 400. 5G UE 401 comprises an example of home user devices 101 and roaming user device 102 illustrated in FIG. 1, although user devices 101 and 102 may differ. UE 401 comprises 5G radio 601 and user circuitry 602. 5G Radio 601 comprises 5GNR antennas, amplifiers, filters, modulation, analog-to-digital interfaces, Digital Signal Processers (DSP), memory, and transceivers (XCVRs) that are coupled over bus circuitry. User circuitry 602 comprises memory, CPU, user interfaces and components, and transceivers that are coupled over bus circuitry.

The memory in user circuitry 602 stores an operating system (OS), user applications, 5GNR network applications for PHY, MAC, RLC, PDCP, SDAP, and RRC, and a DNN for SASE 460. The antenna in 5G radio 601 is wirelessly coupled to 5G RAN 440 over a 5GNR link. A transceiver in radio 601 is coupled to a transceiver in user circuitry 602. A transceiver in user circuitry 602 is typically coupled to the user interfaces and components like displays, controllers, and memory.

In 5G radio 601, the antennas receive wireless signals from 5G RAN 440 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 602 over the transceivers. In user circuitry 602, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 601, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 440 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). The SASE DNN is provisioned by home 5G communication network 400 and allows 5G UE 401 to request PDU sessions with SASE 460.

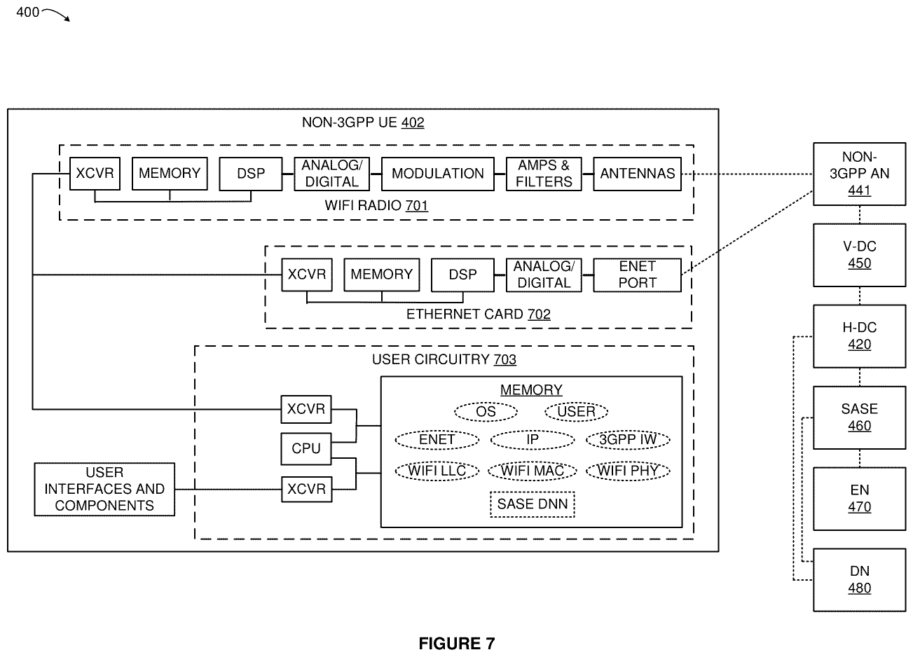

FIG. 7 illustrates non-3GPP UE 402 in home 5G communication network 400. Non-3GPP UE 402 comprises an example of home user devices 101 and roaming user device 102 illustrated in FIG. 1, although user devices 101 and 102 may differ. Non-3GPP UE 402 comprises Wifi radio 701, ethernet card 702, and user circuitry 703. Wifi radio 701 comprises Wifi antennas, amplifiers, filters, modulation, analog-to-digital interfaces, DSP, memory, and transceivers that are coupled over bus circuitry. Ethernet card 702 comprises an ethernet port, analog-to-digital interfaces, DSP, memory, and transceivers. User circuitry 703 comprises memory, CPU, user interfaces and components, and transceivers that are coupled over bus circuitry.

The memory in user circuitry 703 stores an operating system (OS), user applications, an Internet Protocol (IP) application, an ethernet application (ENET), a 3GPP interworking application (3GPP IW), Wifi applications for PHY, MAC, and Logical Link Control (LLC), and DNN for SASE 460. The antenna in Wifi radio 701 is wirelessly coupled to non-3GPP AN 441. The ethernet port in ethernet card 702 is wireline coupled to non-3GPP AN 441. Transceivers in radio 701 and card 702 are coupled to a transceiver in user circuitry 703. A transceiver in user circuitry 703 is typically coupled to the user interfaces and components like displays, controllers, and memory. The CPU in user circuitry 703 executes the operating system, ethernet application, non-3GPP interworking application, IP application, and/or WiFi applications to exchange signaling and data with non-3GPP AN 441 over Wifi radio 701 and/or ethernet card 702.

LLC functions comprise synchronization, multiplexing, flow control, and error-checking. The 3GPP interworking application functions comprise 3GPP to non-3GPP signal and protocol translation. The Wifi MAC and PHY comprise similar functionality to the 5GNR MAC and PHY as described with respect to 5G UE 401. The SASE DNN is provisioned by home 5G communication network 400 and allows non-3GPP UE 402 to request PDU sessions with SASE 460. In some examples, non-3GPP UE 402 comprises a WiFi only or an ethernet only device. When non-3GPP UE 402 comprises a WiFi only device, ethernet card 702 and the ethernet application are omitted. When non-3GPP UE 402 comprises an ethernet only device, Wifi radio 701 and the Wifi applications are omitted.

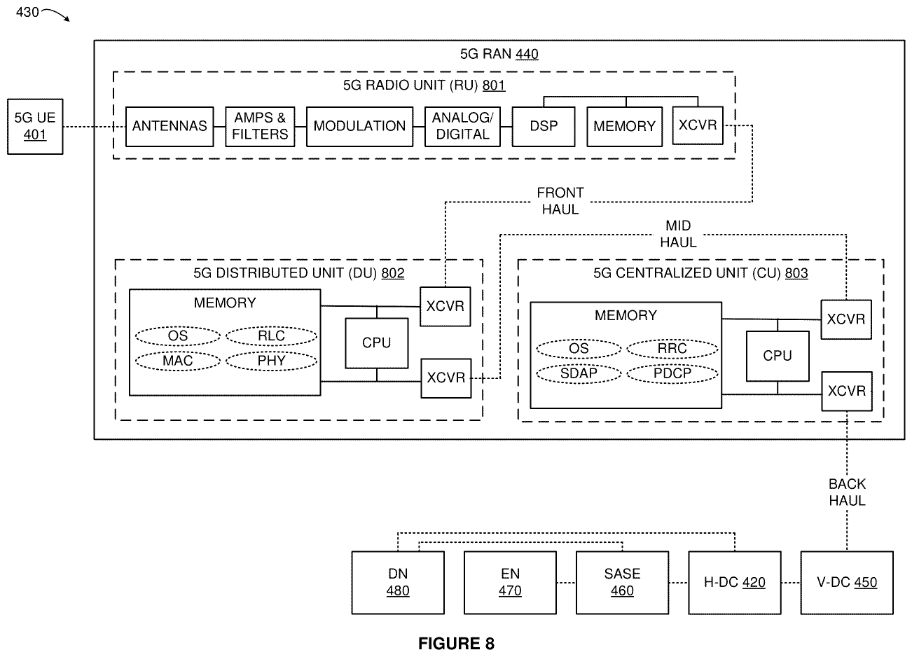

FIG. 8 illustrates 5G RAN 440 in visited 5G communication network 430. 5G RAN 440 comprises an example of the home access network 110 and visited access network 151 illustrated in FIG. 1, although access networks 110 and 151 may differ. 5G RAN 410 comprises a similar architecture to 5G RAN 440. 5G RAN 440 comprises 5G RU 801, 5G DU 802, and 5G CU 803. RU 801 comprises antennas, amplifiers, filters, modulation, analog-to-digital interfaces, DSP, memory, and transceivers (XCVRs) that are coupled over bus circuitry. 5G UE 401 is wirelessly coupled to the antennas in RU 801 over 5GNR links. Transceivers in 5G RU 801 are coupled to transceivers in 5G DU 802 over fronthaul links like enhanced Common Public Radio Interface (eCPRI). The DSPs in RU 801 executes their operating systems and radio applications to exchange 5GNR signals with 5G UE 401 to exchange 5GNR data with DU 802.

For the uplink, the antennas receive wireless signals from 5G UE 401 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 802 over the transceivers.

For the downlink, the DSPs receive downlink 5GNR symbols from DU 802. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to 5G UE 401 that transport the downlink 5GNR signaling and data.

DU 802 comprises memory, CPU, and transceivers that are coupled over bus circuitry. The memory in 5G DU 802 stores operating systems and 5GNR network applications like PHY, MAC, and RLC. CU 803 comprises memory, CPU, and transceivers that are coupled over bus circuitry. The memory in CU 803 stores an operating system and 5GNR network applications like PDCP, SDAP, and RRC. Transceivers in 5G DU 802 are coupled to transceivers in RU 801 over front-haul links. Transceivers in DU 802 are coupled to transceivers in CU 803 over mid-haul links. A transceiver in CU 803 is coupled to network core 520 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

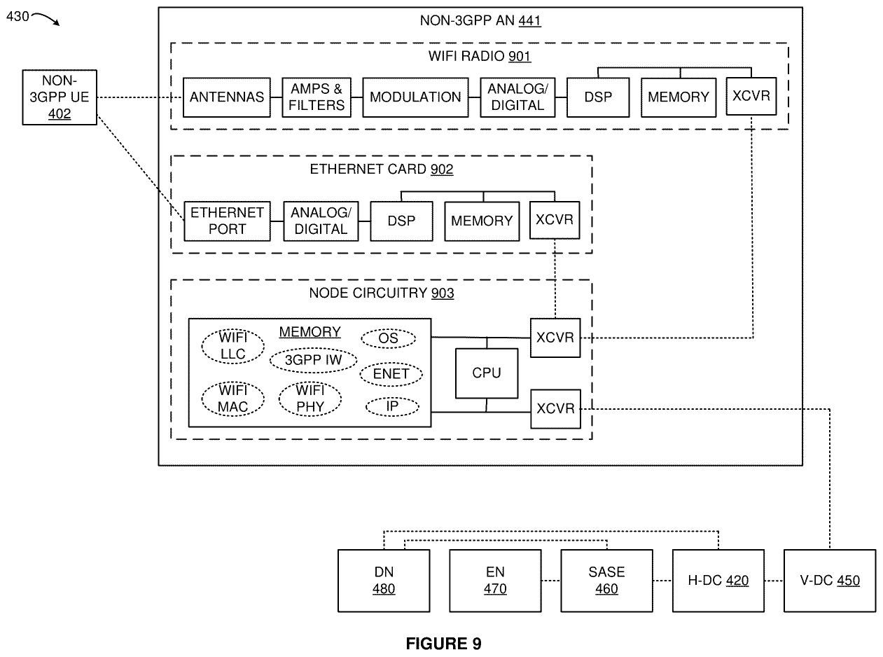

FIG. 9 illustrates non-3GPP AN 441 in visited 5G communication network 430. Non-3GPP AN 441 comprises an example of the home access network 110 and visited access network 151 illustrated in FIG. 1, although access networks 110 and 151 may differ. Non-3GPP AN 411 comprises a similar architecture to non-3GPP AN 441. Non-3GPP AN 441 comprises WiFi radio 901, ethernet card 902, and node circuitry 903. Non-3GPP AN 441 may comprise a trusted access node or an untrusted access node. WiFi radio 901 comprises antennas, amplifiers, filters, modulation, analog-to-digital interfaces, DSP, memory, and transceivers that are coupled over bus circuitry. Ethernet card 902 comprises an ethernet port, analog-to-digital interfaces, DSP, memory, and transceivers that are coupled over bus circuitry. Node circuitry 903 comprises memory, CPU, and transceivers that are coupled over bus circuitry. The memory in node circuitry 903 stores operating systems and network applications like WiFi PHY, WiFi MAC, WiFi LLC, an ethernet application, IP, and 3GPP interworking (3GPP IW). Other wireless protocols like bluetooth and narrowband internet-of-things could be used.

The antennas in WiFi radio 901 are wirelessly coupled to non-3GPP UE 402 over non-3GPP wireless links. The ethernet port in ethernet card 902 are wireline coupled to non-3GPP UE 402 over non-3GPP wired links. Transceivers in WiFi radio 901 and ethernet card 902 are coupled to transceivers in node circuitry 903. Transceivers in node circuitry 903 are coupled to transceivers in N3IWF 455 in visited data center 450 over backhaul links. The CPU in node circuitry 903 executes the operating system and network applications to exchange data and signaling with non-3GPP UE 402. In some examples, non-3GPP AN 441 comprises a WiFi only or an ethernet only AN. When non-3GPP AN 441 comprises a WiFi only AN, ethernet card 902 and the ethernet application are omitted. When non-3GPP AN 441 comprises an ethernet only AN, WiFi radio 901 and the WiFi applications are omitted.

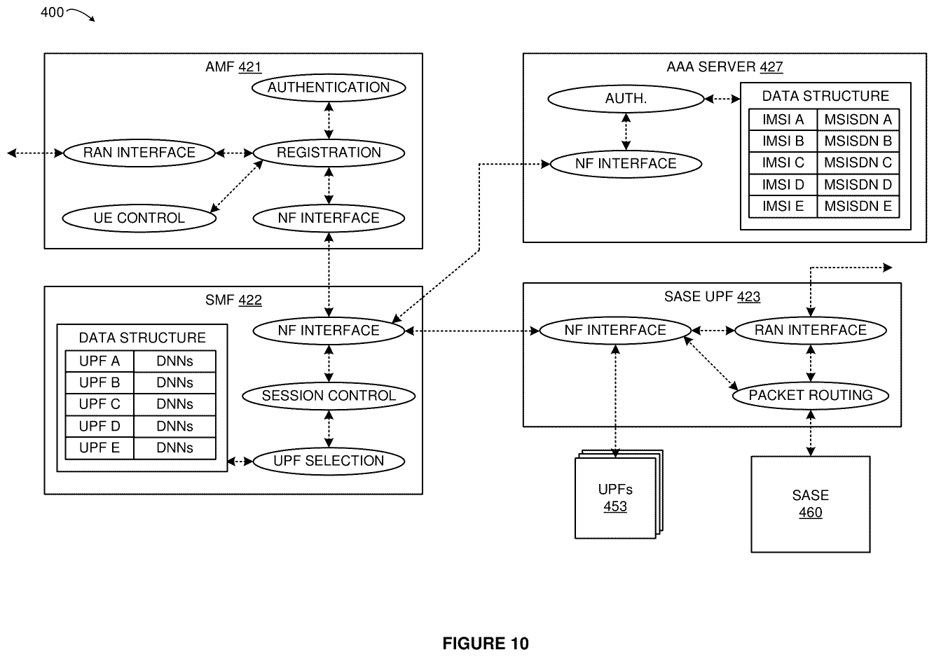

FIG. 10 illustrates AMF 421, SMF 422, SASE UPF 423, and AAA server 427 in home 5G communication network 400. AMF 421 comprises modules for network function (NF) interfacing, RAN interfacing, UE control, registration, and authentication. The registration module processes registration requests received from UEs, generates context for the registrations, and registers UEs for service responsive to authentication. The authentication module provides authentication challenges and confirms authentication responses to authenticate UEs. The UE control module manages the connection and mobility status (e.g., handover control) for UEs.

SMF 422 comprises modules for network function interfacing, session control, and UPF selection, and hosts a data structure that correlates DNNs and UPFs in home 5G data center 420. The session control module activates PDU sessions, enforces session policies (e.g., AMBR), initiates secondary authentication for UEs, and controls UPFs. When secondary authentication is required, the session control module communicates with AAA server 427 to authorize PDU sessions based on a subscriber ID like IMSI or SUPI. The UPF selection module selects UPFs to support PDU session based on DNNs. The UPF selection module inputs requested DNNs into the data structure which outputs UPF IDs that support the DNNs. As illustrated in FIG. 10, the data structure correlates UPFs A-E with various DNNs. For example, the data structure may correlate the UPF ID of SASE UPF 423 with the DNN for SASE 460. SASE UPF 423 comprises modules for network function interfacing, RAN interfacing, and packet routing. The packet routing module routes packets between UEs, UPFs 453 in visited 5G data center 450, SASE 460, enterprise network 470, and/or data network 480.

AAA server 427 comprises modules for network function interfacing and secondary authentication, and hosts a data structure that correlates subscriber IMSIs with device MSISDNs. The authentication module validates UE requests for PDU sessions with enterprise network 470 by correlating device IMSIs with MSISDNs associated with SASE 460 and/or enterprise network 470. As illustrated in FIG. 10, the data structure stores bindings that associate IMSIs A-E with MSISDNs A-E. The authentication module may query the data structure with an IMSI for a UE and the data structure may return an output that indicates if the IMSI is associated with an MSISDN. When the output indicates the IMSI is associated with an MSISDN, the authentication module authorizes the PDU session. Likewise, when the output indicates the IMSI is not associated with an MSISDN, the authentication module blocks the PDU session.

The network function interface and RAN interface modules allow the network functions to communicate with each other, with RAN 410 and non-3GPP AN 411, and with external systems like visited 5G data center 450. For example, the interface modules may comprise Application Programing Interfaces (APIs).

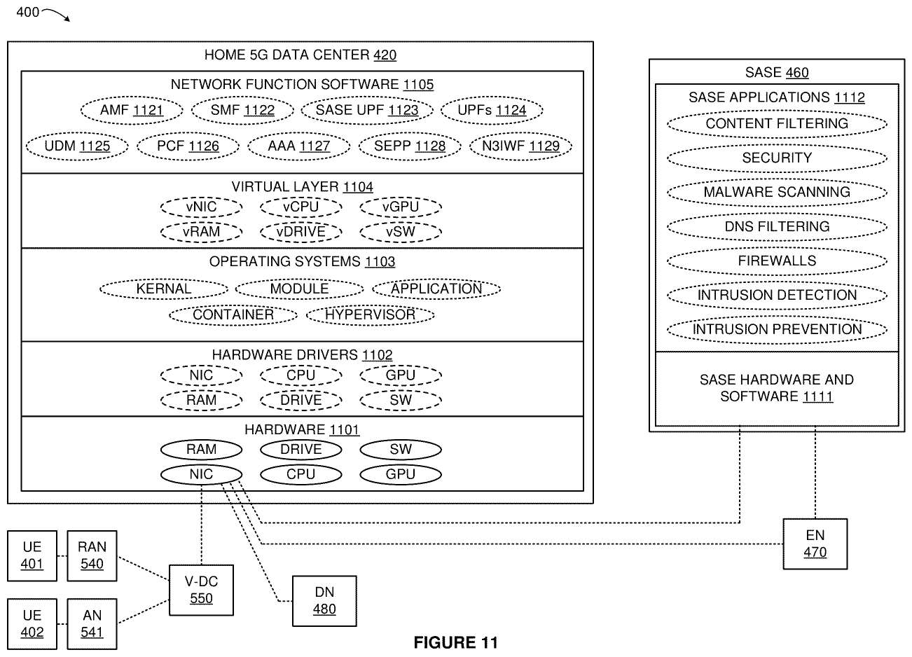

FIG. 11 illustrates home 5G data center 420 and SASE 460 in home 5G communication network 400. Home 5G data center 420 comprises an example of home core network 120 and visited core network 152 illustrated in FIG. 1, although core networks 120 and 152 may differ. SASE 460 comprises an example of edge security platform 130 illustrated in FIG. 1, although edge security platform 130 may differ. Home 5G data center 420 and SASE 460 typically utilize a virtualized computing architecture like NFVI, however other types of computing architectures may be used. Visited 5G data center 450 may be similar to home 5G data center 420. Home 5G data center 420 comprises hardware 1101, hardware drivers 1102, operating systems 1103, virtual layer 1104, and network function software 1105. Hardware 1101 comprises Network Interface Cards (NICs), CPU, GPU, RAM, Flash/Disk Drives (DRIVE), and Data Switches (SW). Hardware drivers 1102 comprise software that is resident in the NIC, CPU, GPU, RAM, DRIVE, and SW. Operating systems 1103 comprise kernels, modules, applications, containers, hypervisors, and the like. Virtual layer 1104 comprises vNIC, vCPU, vGPU, vRAM, vDRIVE, and vSW. Network function software 1105 comprises AMF 1121, SMF 1122, SASE UPF 1123, UPFs 1124, UDM 1125, PCF 1126, AAA 1127, SEPP 1128, and N3IWF 1129. Additional network function software like AUSF, SMSF, NSSF, NEF, NRF, and AF is typically present but are omitted for clarity.

SASE 460 comprises SASE hardware and software 1111 and SASE applications 1112. SASE hardware and software 1111 comprises NICs, CPU, GPU, RAM, DRIVE, and SW and hardware drivers resident in the NIC, CPU, GPU, RAM, DRIVE, and SW. SASE hardware and software 1111 comprises operating systems like kernels, modules, applications, containers, and hypervisors as well as a virtual layer that comprises vNIC, vCPU, vGPU, vRAM, vDRIVE, and vSW. SASE applications 1112 comprise applications for content filtering, security, malware scanning, DNS filtering, firewalls, intrusion detection, and intrusion prevention. Additional SASE applications are typically present but are omitted for clarity.

SASE 460 comprises a unified, cloud-native approach to security, merging multiple functions into a single service, which contrasts with the fragmented nature of traditional network routing and security architectures. SASE 460 ensures real-time, context aware policy enforcement, securing user and device traffic and enhancing user experience when compared to other security solutions. SASE 460's inherent flexibility, cost efficiency, and zero trust architecture surpasses the capabilities of traditional firewalls or VPNs, making it appropriate for expanded business needs. By consolidating security functions for end-users, remote IoT devices, branches and offices, SASE 460 not only simplifies the security landscape but also future-proofs organizations against evolving challenges.

SASE 460 combines network security functions with Wide Area Network (WAN) capabilities to support organizations' dynamic, secure access needs. SASE 460 may support security features like Zero Trust Network Access (ZTNA), Secure Web Gateways (SWG), Cloud Access Security Brokers (CASB), and Firewall as a Service (FWaaS), among others. This integrated approach allows organizations to provide secure and optimized connectivity to cloud services, applications, and resources from any location or device. SASE 460 decentralizes the security and networking architecture, ensuring remote and mobile users can connect directly to their destinations without being routed through a centralized data center. This eliminates the need for backhauling, which traditionally rerouted traffic through a central point to access internal applications and apply security, increasing latency from the added transport distance. With SASE 460, users experience faster and more efficient connectivity, remaining as local as possible, enhancing productivity and user experience.

Home 5G data center 420 and SASE 460 may be co-located, each located at a single site, or be distributed across multiple geographic locations. The NIC in hardware 1101 is coupled to 5G RAN 410, non-3GPP AN 411, visited data center (V-DC) 450, the NIC in SASE hardware and software 1111, enterprise network (EN) 470, data network (DN) 480, and to external systems (not illustrated). The NIC in SASE hardware and software 1111 is coupled to the NIC in hardware 1101 and to enterprise network 470. The link between home 5G data center 420 and SASE 460 may comprise a direction connection or an indirect connection. Hardware 1101 executes hardware drivers 1102, operating systems 1103, virtual layer 1104, and network function software 1105 to form AMF 421, SMF 422, security UPF 423, UPFs 424, UDM 425, PCF 426, AAA server 427, SEPP 428, and N3IWF 429. The hardware in SASE hardware and software and software 1111 executes the hardware drivers, operating systems, virtual layer, and SASE applications 1112 to form the SASE applications illustrated in FIG. 11.

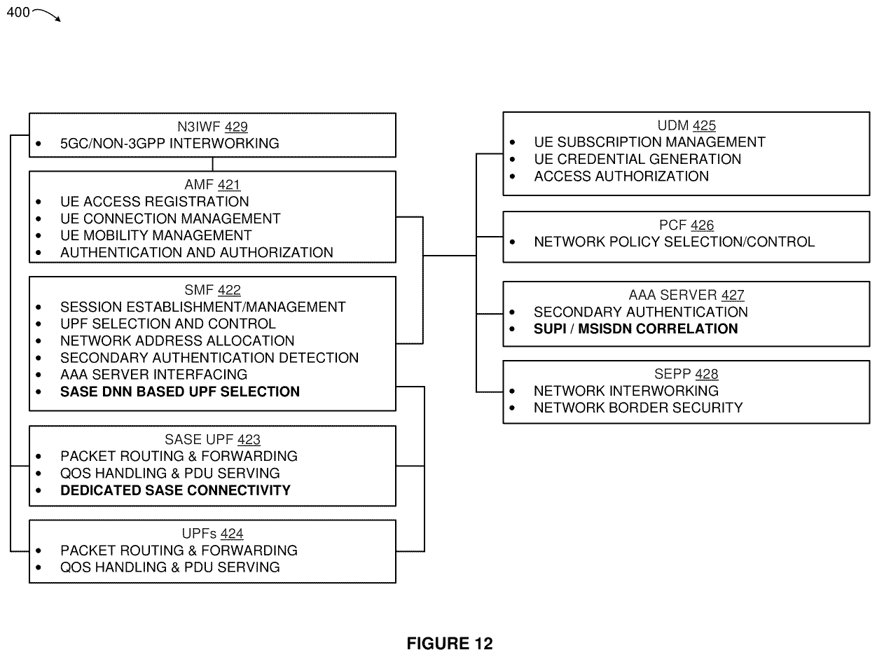

FIG. 12 further illustrates home 5G data center 420 in home 5G communication network 400. AMF 421 comprises capabilities for UE registration, UE connection management, UE mobility management, authentication, and authorization. SMF 422 comprises capabilities for session establishment, session management, UPF selection, UPF control, network address allocation, secondary authentication detection, AAA server interfacing, and SASE DNN based UPF selection. SASE UPF 423 comprises capabilities for packet routing, packet forwarding, QoS handling, PDU serving, and dedicated SASE connectivity. UPFs 424 comprise capabilities for packet routing, packet forwarding, QoS handling, and PDU serving. UDM 425 comprises capabilities for UE subscription management, UE credential generation, and UE access authorization. PCF 426 comprises capabilities for network policy selection and control. AAA server 427 comprises capabilities for secondary authentication and IMSI/MSISDN correlation. SEPP 428 comprises capabilities for network interworking and network border security. N3IWF 429 comprises capabilities for 5GC/non-3GPP interworking.

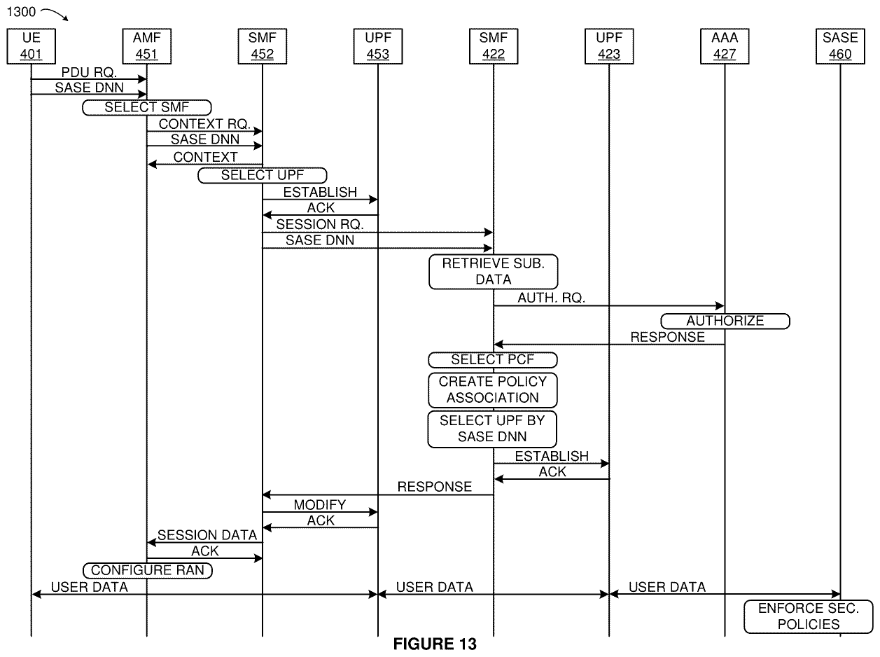

FIG. 13 illustrates process 1300. Process 1300 comprises an exemplary operation of home 5G communication network 400 to provide edge-based security service to roaming user devices. Process 1300 comprises an example of processes 200 and 300 illustrated in FIGS. 2 and 3, however processes 200 and 300 may differ. Process 1300 may vary in other examples. In some examples, 5G UE 401 roams on visited 5G communication network 430. UE 401 wirelessly transfers a PDU session request to AMF 451 over 5G RAN 440. The PDU session request includes the DNN for SASE 460. AMF 451 selects SMF 452 to manage the requested PDU session. AMF 451 transfers a session context request, indicates the SASE DNN, and indicates that UE 401 is a roaming device from home 5G communication network 400 to SMF 452.

SMF 452 generates context for the session and returns the context to AMF 451. SMF 452 selects one of UPFs 453 to support the session. SMF 452 directs the selected one of UPFs 453 to establish a data link for the PDU session. The selected one of UPFs 453 creates the data link for the session and returns an acknowledgement to SMF 452 to confirm data link creation. For example, the selected one of UPFs 453 may reserve computing resources to support packet routing/forwarding to serve the PDU session to UE 401. SMF 452 transfers a PDU session request for UE 401 to SMF 422 in home 5G data center over SEPPs 428 and 454 based on the HPLMN-ID of UE 401. The request includes the DNN for SASE 460 received from UE 401, the IMSI/SUCI of UE 401, and the network address for the selected one of UPFs 453. SMF 422 retrieves subscriber data (e.g., SUPI, allowed DNNs, allowed S-NSSAI, etc.) for UE 401 from UDM 425. SMF 422 identifies the PDU session is with enterprise network 470 based on the request from SMF 452 and/or the subscriber data.

In response, SMF 422 initiates secondary authentication to authorize the PDU session by transferring an authentication request to AAA server 427. The request indicates UE 401's SUPI/IMSI to AAA server 427. AAA server 427 determines if UE 401's IMSI is associated with an MSISDN registered with enterprise network 470. AAA server 427 compares UE 401's SUPI/IMSI to the data structure and confirms UE 401 is authorized for service on enterprise network 470. AAA server 427 transfers a response to SMF 422 to notify SMF 422 that UE 401's PDU session with SASE 460 and enterprise network 470 is authorized.

Responsive to PDU session authorization, SMF 422 selects PCF 426 to create a policy association for the session. PCF 426 provides network policies and rules (e.g., QoS policies, latency rules, throughput rules, traffic treatment policies, etc.) based on UE 401's subscription. SMF 422 identifies the DNNs served by UPFs 423 and 424. SMF 422 compares the SASE DNN requested by UE 401 to the DNNs served by UPFs 423 and 424 and selects SASE UPF 423. SMF 422 directs SASE UPF 423 to establish a data link to support the PDU session and indicates the network address of the selected one of UPFs 453 to SASE UPF 423. SASE UPF 423 establishes the data link and responds with an acknowledgement to SMF 422 to confirm data link creation.

SMF 422 transfers a PDU create session response to SMF 452. The response authorizes the PDU session and includes the network address for SASE UPF 423. SMF 452 transfers a session modification command to the selected one of UPFs 453 to indicate the network address of SASE UPF 423. The selected one of UPFs 453 establishes a data link with SASE UPF 423 and transfers an acknowledgement to SMF 452. SMF 452 provides session data (e.g., UPF network addresses, QoS, etc.) to AMF 451 which transfers an acknowledgement to SMF 452 to confirm receipt of the data. AMF 451 configures 5G RAN 440 to serve the PDU session to UE 401 and directs UE 401 to begin the session. UE 401 exchanges user data for the PDU session with the selected one of UPFs 453 over 5G RAN 440. The selected one of UPFs 453 exchanges the user data with SASE UPF 423. SASE UPF 423 exchanges the user data with SASE 460. SASE 460 enforces security policies on the session (e.g., content filtering, security features, malware scanning, DNS filtering, firewalls, intrusion detection intrusion prevention, etc.). SASE 460 exchanges the user data with enterprise network 470.

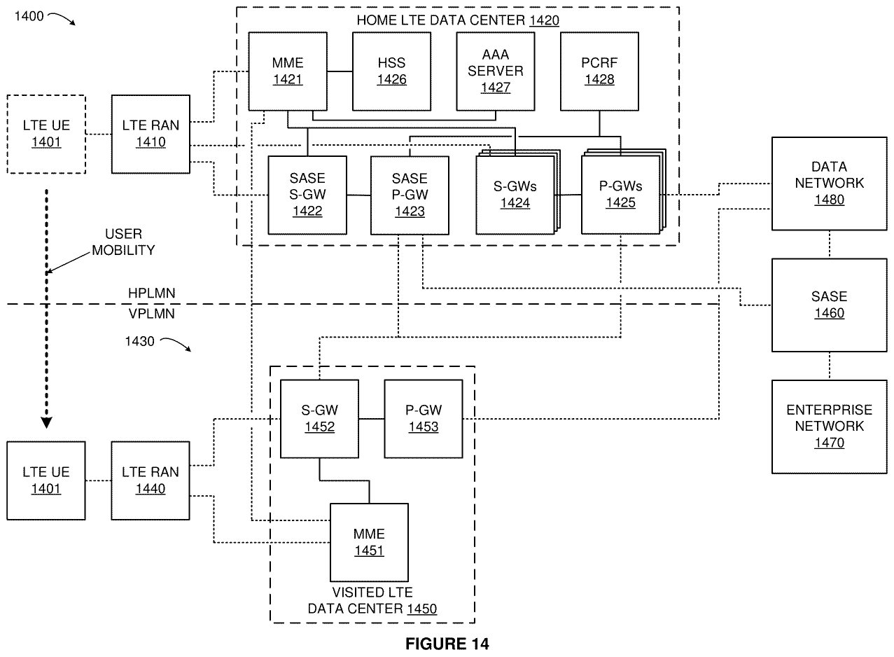

FIG. 14 illustrates home LTE communication network 1400 and visited LTE communication network 1430 to provide edge-based security service to roaming user devices. Home LTE communication network 1400 comprises an example of home communication network 100 illustrated in FIG. 1 and home 5G communication network 400 illustrated in FIG. 4, however networks 100 and 400 may differ. Home LTE communication network 1400 comprises LTE UE 1401, LTE RAN 1410, home LTE data center 1420, SASE 1460, enterprise network 1470, and data network 1480. Home LTE data center 1420 comprises MME 1421, SASE S-GW 1422, SASE P-GW 1423, S-GWs 1424, P-GWs 1425, HSS 1426, AAA server 1427, and PCRF 1428. Visited LTE communication network 1430 comprises LTE RAN 1440 and visited LTE data center 1450. Visited LTE data center 1450 comprises MME 1451, S-GW 1452, and P-GW 1453. Other network functions and network entities are typically present in home LTE data center 1420 but are omitted for clarity. In other examples, home LTE communication network 1400 may comprise different or additional elements than those illustrated in FIG. 14.

In some examples, home LTE network 1400 operates similarly to home 5G network 400 to provide SASE functionality to roaming user devices. LTE UE 1401 attaches to LTE RAN 1410. LTE UE 1401 communicates with MME 1421 over LTE RAN 1410 to register for service on home LTE communication network 1400. MME 1421 interfaces with HSS 1426 and typically the other network functions/entities in home LTE data center 1420 to authenticate, authorize, and register LTE UE 1401 for service. Subsequently, LTE UE 1401 moves out of the service area of LTE RAN 1410 and enters the service area of LTE RAN 1440 due to user mobility. In response, LTE UE 1401 decides to roam on visited LTE communication network 1430. LTE UE 1401 attaches to LTE RAN 1440 and transfers a session request that indicates the APN for SASE 1460 to MME 1451. It should be appreciated that APN is the LTE analog of DNN used in 5G networks.

MME 1451 interfaces with MME 1421 in home LTE data center 1420 to authorize the session and select a P-GW for the session. S-GWs 1422 and 1424 and P-GWs 1423 and 1425 are associated with various APNs. The APNs correspond to data endpoints like SASE 1460, enterprise network 1470, and data network 1480. SASE S-GW 1422 and SASE P-GW 1423 serve as a dedicated gateway for SASE 1460 and are associated with SASE 460's APN. MME 1421 determines that SASE P-GW supports the APN requested by LTE UE 401. For example, MME 1421 may compare the APNs of P-GWs 1423 and 1425 to the APN requested by LTE UE 1401 and responsively select SASE P-GW 1423 to support the session. MME 1421 may interface with AAA server 1427 to authorize the session with enterprise network 1470.

MME 1421 directs SASE P-GW 1423 to support the session and provides the network address for SASE P-GW 1423 to MME 1451. MME 1451 directs S-GW 1452 to route data for the session to SASE P-GW 1423 and directs LTE UE 1401 to begin the session. LTE UE 1401 exchanges user data with S-GW 1452 over LTE RAN 1440. S-GW 1452 routes the user data to SASE P-GW 1423. SASE P-GW 1423 exchanges the user data with SASE 1460. SASE 1460 enforces security policies on the data and exchanges the data with enterprise network 1470. PCRF 1428 may interface with SASE P-GW 1423 to enforce network policies (e.g., QoS rules, bitrate, latency, throughput, etc.) on the session.

The wireless data network circuitry described above comprises computer hardware and software that form special-purpose network circuitry to provide edge-based security service to roaming user devices. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to provide edge-based security service to roaming user devices.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
receiving, by a network controller in a home communication network from a visited communication network, a session request for a roaming user device that is roaming on the visited communication network, wherein the session request at least indicates an edge security platform of the home communication network;
selecting, by the network controller, a user plane in the home communication network with a communication link to the edge security platform;
directing, by the network controller, the user plane to support a session for the roaming user device with the visited communication network;
transferring, by the network controller, a response to the visited communication network to begin the session;
exchanging, by the user plane, user data for the session with the visited communication network wherein the visited communication network exchanges the user data for the session with the roaming user device; and
exchanging, by the user plane, the user data for the session with the edge security platform wherein the edge security platform enforces security policies on the session.

2. The method of claim 1 wherein:
receiving, by the network controller, the session request that at least indicates the edge security platform comprises receiving, by the network controller, the session request that includes a Data Network Name (DNN) that identifies the edge security platform; and
selecting, by the network controller, the user plane with the communication link to the edge security platform comprises selecting, by the network controller, the user plane based on the DNN.

3. The method of claim 1 wherein:
receiving, by the network controller, the session request that at least indicates the edge security platform comprises receiving, by the network controller, the session request that includes an Access Point Name (APN) that identifies the edge security platform; and
selecting, by the network controller, the user plane with the communication link to the edge security platform comprises selecting, by the network controller, the user plane based on the APN.

4. The method of claim 1 wherein transferring, by the network controller, the response to the visited communication network to begin the session comprises transferring, by the network controller, the response to the visited communication network to begin the session and that directs the visited communication network to route the user data to the user plane.

5. The method of claim 1 wherein:
receiving, by the network controller, the session request that at least indicates the edge security platform comprises receiving, by the network controller, the session request that indicates the edge security platform and a subscriber Identifier (ID) for the roaming user device;
and further comprising:
transferring, by the network controller, a session authorization request that includes the subscriber ID to an authentication server;
authorizing, by the authentication server, the roaming user device for the session with the edge security platform based on the subscriber ID;
transferring, by the authentication server, a session authorization response to the network controller that indicates the session with the edge security platform for the roaming user device is authorized; and wherein:
selecting, by the network controller, the user plane with the communication link to the edge security platform comprises selecting, by the network controller, the user plane with the communication link to the edge security platform based on the session authorization response.

6. The method of claim 4 wherein:
the subscriber ID comprises one of a Subscriber Permanent Identifier (SUPI) or an International Mobile Subscriber Identity (IMSI); and
authorizing, by the authentication server, the roaming user device for the session with the edge security platform based on the subscriber ID comprises correlating, by the authentication service, the one of the SUPI or the IMSI with a Mobile Station International Subscriber Directory Number (MSISDN) associated with the edge security platform to authorize the roaming user device for the session with the edge security platform.

7. The method of claim 1 wherein the security policies comprise one or more of content filtering, security features, malware scanning, Domain Name System (DNS) filtering, firewalls, intrusion detection, and intrusion prevention.

8. A system comprising:
a network controller in a home communication network configured to:
receive a session request from a visited communication network for a roaming user device that is roaming on the visited communication network, wherein the session request at least indicates an edge security platform of the home communication network;
select a user plane in the home communication network with a communication link to the edge security platform;
direct the user plane to support a session for the roaming user device with the visited communication network; and
transfer a response to the visited communication network to begin the session; and
the user plane configured to:
exchange user data for the session with the visited communication network wherein the visited communication network exchanges the user data for the session with the roaming user device; and
exchange the user data for the session with the edge security platform wherein the edge security platform enforces security policies on the session.

9. The system of claim 8 wherein:
the session request includes a Data Network Name (DNN) that identifies the edge security platform; and
the network controller is further configured to select the user plane based on the DNN.

10. The system of claim 8 wherein:
the session request includes an Access Point Name (APN) that identifies the edge security platform; and
the network controller is further configured to select the user plane based on the APN.

11. The system of claim 8 wherein the response directs the visited communication network to route the user data to the user plane.

12. The system of claim 8 further comprising an authentication server; and wherein:
the session request indicates the edge security platform and a subscriber Identifier (ID) for the roaming user device; and
the network controller is further configured to:
transfer a session authorization request that includes the subscriber ID to the authentication server; and
the authentication server is configured to:
correlate the subscriber ID with a user device phone number associated with the edge security platform to authorize the roaming user device for the session with the edge security platform; and
transfer a session authorization response to the network controller that indicates the session with the edge security platform for the roaming user device is authorized; and
the network controller is further configured to:
select the user plane with the communication link to the edge security platform based on the session authorization response.

13. The system of claim 8 wherein:
the network controller comprises a Session Management Function (SMF); and
the user plane comprises a User Plane Function (UPF).

14. The system of claim 8 wherein:
the network controller comprises a Mobility Management Entity (MME); and
the user plane comprises a Session Gateway (S-GW) and a Packet Gateway (P-GW).

15. One or more non-transitory computer readable storage media having program instructions stored thereon, wherein the program instruction, when executed by a computing system, direct the computing system to perform operations, the operations comprising:
receiving, in a home communication network, a session request from a visited communication network for a roaming user device that is roaming on the visited communication network, wherein the session request at least indicates an edge security platform of the home communication network;
selecting a user plane with a communication link to the edge security platform;
directing the user plane to support a session for the roaming user device with the visited communication network; and
transferring a response to the visited communication network to begin the session wherein the user plane exchanges user data for the session with the visited communication network and exchanges the user data for the session with the edge security platform, the visited communication network exchanges the user data for the session with the roaming user device, and the edge security platform enforces security policies on the session.

16. The computer readable storage media of claim 15 wherein:
receiving the session request that at least indicates the edge security platform comprises receiving the session request that includes a Data Network Name (DNN) that identifies the edge security platform; and
selecting the user plane with the communication link to the edge security platform comprises selecting the user plane based on the DNN.

17. The computer readable storage media of claim 15 wherein:
receiving the session request that at least indicates the edge security platform comprises receiving the session request that includes an Access Point Name (APN) that identifies the edge security platform; and
selecting the user plane with the communication link to the edge security platform comprises selecting the user plane based on the APN.

18. The computer readable storage media of claim 15 wherein transferring the response to the visited communication network to begin the session comprises transferring the response to the visited communication network to begin the session and that directs the visited communication network to route the user data to the user plane.

19. The computer readable storage media of claim 15 wherein
receiving the session request that at least indicates the edge security platform comprises receiving the session request that indicates the edge security platform and a subscriber Identifier (ID) for the roaming user device; and wherein the operations further comprise:
transferring a session authorization request that includes the subscriber ID to an authentication server wherein the authentication server authorizes the roaming user device for the session with the edge security platform based on the subscriber ID and returns a session authorization response that indicates the session with the edge security platform for the roaming user device is authorized; and wherein:
selecting the user plane with the communication link to the edge security platform comprises selecting the user plane with the communication link to the edge security platform based on the session authorization response.

20. The computer readable storage media of claim 15 wherein the security policies comprise one or more of content filtering, security features, malware scanning, Domain Name System (DNS) filtering, firewalls, intrusion detection, and intrusion prevention.
